(19) United States
(12) Patent Application Publication
(10) Pub. No.: US 2025/0290597 A1
(43) Pub. Date: Sep. 18, 2025

(54) WALL MOUNTED EQUIPMENT SUPPORT

(71) Applicant: ERICO International Corporation, Solon, OH (US)

(72) Inventor: Scott Ernest Anderson, Garrettsville, OH (US)

(21) Appl. No.: 19/073,293

(22) Filed: Mar. 7, 2025

Related U.S. Application Data
(60) Provisional application No. 63/565,704, filed on Mar. 15, 2024.

(51) Int. Cl. F16M 13/02

(52) U.S. Cl. CPC F16M 13/02

(57) ABSTRACT

A bracket is provided for equipment that can be configured for use with a support member, a first cross bar, and a second cross bar. The first and second cross bars extend in a lateral direction and are supported by the support member. The bracket can be configured for use with an arm, the arm including a first end with a first anchor feature and a second end configured to be secured to equipment. The first anchor feature can removably engage with one of the first cross bar or the second cross bar to secure the arm to the bracket, with the arm seated on and below the first cross bar, the arm seated on and above the second cross bar, and the second end of the arm extending away from the bracket, transverse to the lateral direction, to support the equipment in cantilevered support relative to the bracket.

### CROSS-REFERENCE TO RELATED APPLICATIONS

This application claims the benefit of the U.S. Provisional Patent Application No. 63/565,704, filed Mar. 15, 2024, which is incorporated herein by reference in its entirety.

### BACKGROUND

Mounting system for equipment can be used to mount various type of equipment. Mounting systems for equipment typically include a piece of equipment, which can range from large to small sizes. The mounting system typically includes a cross bar, and the mounting system may be located on the ground or mounted to a wall.

### SUMMARY

Some embodiments of the disclosure provide a mounting system for equipment comprising a wall-mounted bracket, a first arm that includes a first end with a first-arm anchor feature and a second end configured to be secured to equipment, a second arm that includes a third end with a second-arm anchor feature and a fourth end configured to be secured to the equipment, a first-arm anchor feature, and a second-arm anchor feature. The wall-mounted bracket includes a support member securable to a wall, a first cross bar that extends in a lateral direction, supported by the support member, and a second cross bar that extends in the lateral direction, supported by the support member. The first-arm anchor feature removably engages the first cross bar to secure the first arm to the first cross bar, with the first arm extending below the first cross bar and the first arm extending above the second cross bar to be removably seated on the second cross bar, so that the second end of the first arm extends transverse to the lateral direction to support the equipment with cantilevered support relative to the wall-mounted bracket. The second-arm anchor feature removably engages the first cross bar to secure the second arm to the first cross bar, with the second arm extending below the first cross bar and the second arm extending above the second cross bar to be removably seated on the second cross bar, so that the fourth end of the second arm extends transverse to the lateral direction to support the equipment with cantilevered support relative to the wall-mounted bracket.

Other embodiments of the disclosure provide a mounting system for equipment comprising a bracket and an arm that includes a first end with a first anchor feature and a second end configured to be secured to equipment. The bracket includes a support member, a first cross bar that extends in a lateral direction, supported by the support member, and a second cross bar that extends in the lateral direction, supported by the support member. The first anchor feature removably engages one of the first cross bar or the second cross bar to secure the arm to the bracket, with the arm seated on and below the first cross bar, the arm seated on and above the second cross bar, and the second end of the arm extending away from the bracket, transverse to the lateral direction, to support the equipment in cantilevered support relative to the bracket.

Some embodiments of the disclosure provide a method of supporting equipment comprising securing a support member of a bracket to a support structure with a first cross bar of the bracket extending in a lateral direction, supported by the support member, and a second cross bar of the bracket extending in the lateral direction, supported by the support member; and providing an arm that includes a first end with a first anchor feature and a second end. The method further comprises removably engaging the first anchor feature with one of the first cross bar or the second cross bar to secure the arm to the bracket, with the arm seated on and below the first cross bar, the arm is seated on and above the second cross bar, and the second end of the arm extending away from the bracket, transverse to the lateral direction; and removably engaging the first anchor feature with one of the first cross bar or the second cross bar to secure the arm to the bracket, with the arm seated on and below the first cross bar, the arm is seated on and above the second cross bar, and the second end of the arm extending away from the bracket, transverse to the lateral direction; and securing the equipment to the second end of the arm so that, with the arm secured to the bracket, the arm supports the equipment in cantilevered support relative to the bracket.

Some embodiments of the disclosure provide a mounting system for equipment comprising a wall-mounted bracket that includes one or more support members, a first cross bar that extends in a lateral direction and is supported by the one or more support members, and a second cross bar that extends in a lateral direction and is supported by the one or more support members. The mounting system also comprises an arm that includes a first end with a first anchor feature and a second end configured to be secured to equipment. The first anchor feature removably engages the first cross bar with the arm below the first cross bar. The arm is removably seated on the second cross bar with the arm above the second cross bar so that the second end of the arm extends transverse to the lateral direction. The arm is in cantilevered support relative to the wall-mounted bracket to support the equipment.

In some examples, the arm further includes a second anchor feature between the first and second ends of the arm, where the second anchor feature removably engages the second cross bar. In some examples, the first anchor feature extends in a first direction from the arm and the second anchor feature extends in a second direction from the arm that is opposite the first direction. In some examples, the mounting system further comprises the first anchor feature extends in a first direction from the arm and the second anchor feature extends in a second direction from the arm that is opposite the first direction, where the third anchor feature removably engages the first cross bar with the second arm below the first cross bar and the second arm is removably seated on the second cross bar with the second arm above the second cross bar, so that the fourth end of the second arm is in cantilevered support relative to the wall-mounted bracket to support the equipment. In some examples, the first end of the arm extends along a first arm axis and the second end of the arm extends along a second arm axis that is laterally offset from the first arm axis, where the third end of the second arm extends along a third arm axis and the fourth end of the second arm extends along a fourth arm axis that is laterally offset from the third arm axis. In some examples, in a first installation orientation, the second and fourth arm axes are laterally between the first and third arm axes. In some examples, in a second installation orientation, the first and third arm axes are laterally between the second and fourth arm axes. In some examples, the first anchor feature includes a c-clamp. In some examples, the c-clamp includes a set screw arranged to secure the first cross bar within the c-clamp.

Additionally, in some examples, the one or more support members include a first support member that includes first fastener openings to secure the first support member to a wall and a second support member that includes second fastener openings to secure the second support member to the wall. Each of the first and second cross bars extends laterally from a first end secured to the first support member to a second end secured to the second support member. In some examples, relative to an installed orientation of the mounting system on a wall, the first cross bar is above the second cross bar and closer to the wall than is the second cross bar. In some examples, the wall-mountable bracket further includes one or more cross supports that extend laterally between the first and second support members.

Some embodiments of the disclosure provide a method of supporting equipment, the method comprising securing to a wall one or more support members of a wall-mounted bracket, with a first cross bar of the wall-mounted bracket extending in a lateral direction, supported by the one or more support members, and a second cross bar of the wall-mounted bracket extending in the lateral direction, supported by the one or more support members. The method also comprises securing to the wall-mounted bracket an arm that includes a first end with a first anchor feature and a second end, including engaging the first anchor feature with the first cross bar, with the arm below the first cross bar, so that the arm is seated on the second cross bar with the arm above the second cross bar and the second end of the arm extends away from the wall-mounted bracket and the wall, in cantilevered support relative to the wall-mounted bracket. The method further comprises securing the equipment to the arm.

In some examples, the arm further includes a second anchor feature between the first and second ends of the arm, where securing the arm to the wall-mounted bracket further includes engaging the second anchor feature with the second cross bar. In some examples, the method further comprises securing to the wall-mounted bracket a second arm that includes a third end with a third anchor feature and a fourth end, including engaging the third anchor feature with the first cross bar, with the second arm below the first cross bar, so that the second arm is removably seated on the second cross bar with the second arm above the second cross bar and the fourth end of the second arm extends away from the wall-mounted bracket and the wall, in cantilevered support relative to the wall-mounted bracket, and securing the equipment to the second arm. In some examples, the first end of the arm extends along a first arm axis and the second end of the arm extends along a second arm axis that is laterally offset from the first arm axis, where the third end of the arm extends along a third arm axis and the fourth end of the arm extends along a fourth arm axis that is laterally offset from the third arm axis. In some examples, securing the arm and the second arm to the wall-mounted bracket includes, selectively, for a first installation orientation, securing the arm and the second arm so that the second and fourth arm axes are laterally between the first and third arm axes, and for a second installation orientation, securing the arm and the second arm so that the first and third arm axes are laterally between the second and fourth arm axes.

### BRIEF DESCRIPTION OF THE DRAWINGS

The accompanying drawings, which are incorporated in and form a part of this specification, illustrate examples of the disclosed technology and, together with the description, serve to explain the principles of examples of the disclosed technology:

FIG. 1 illustrates a wall-mounted bracket of a mounting system, according to some aspects of the disclosure;

FIG. 2A illustrates arms of a mounting system, according to some aspects of the disclosure, including a side elevation detail view of anchor features of one of the arms;

FIG. 2B is an enlarged view of the arms of FIG. 2A taken from enlarged view indicator II-B of FIG. 2A;

FIG. 3A illustrates another configuration of the wall-mounted bracket of FIG. 1;

FIG. 3B illustrates yet another configuration of the wall-mounted bracket of FIG. 1;

FIG. 4A illustrates another configuration of the arms of FIG. 2A;

FIG. 4B illustrates yet another configuration of the arms of FIG. 2A;

FIG. 4C is an enlarged view of the arms of FIG. 4B taken from enlarged view indicator IV-C of FIG. 4B;

FIG. 5 illustrates an embodiment of a mounting system, according to some aspects of the disclosure;

FIGS. 6A and 6B illustrate a method of installation for the mounting system of FIG. 5; and

FIGS. 7A-7C illustrate various installation orientations of the wall-mounted bracket of FIG. 5.

### DETAILED DESCRIPTION

Before any examples of the disclosed technology are explained in detail, it is to be understood that the disclosure is not limited in its application to the details of construction and the arrangement of components set forth in the following description or illustrated in the following drawings. The disclosure is capable of other examples and of being practiced or of being carried out in various ways.

The following discussion is presented to enable a person skilled in the art to make and use examples of the disclosed technology. Various modifications to the illustrated examples will be readily apparent to those skilled in the art, and the generic principles herein can be applied to other examples and applications without departing from the disclosed technology. Thus, the disclosed technology is not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of disclosed technology. Skilled artisans will recognize the examples provided herein have many useful alternatives and fall within the scope of the disclosed technology.

In various installation, equipment can be installed to a structure. For example, heat pumps, air conditioning units, or other electronic equipment can be installed onto various building structures (e.g., walls, rooftop structures, etc.). Some equipment can be installed on a wall, and other equipment can be installed on a ground mount (e.g., with the ground mount structure supported on the earth, or on the ground surface of a rooftop or other building structure).

Conventional wall mount systems may be relatively difficult and time-consuming to install, may not be easily adapted to varied installation settings or equipment, and may occupy relatively large spatial envelopes once installed (e.g., so as to protrude beyond the supported equipment from some perspectives). For example, some conventional systems can require multiple components to be separately aligned and secured relative to each other and the relevant structure (e.g., a rooftop or other building wall) at select, predetermined locations. Correspondingly, conventional approaches may be cumbersome to manage, as well as presenting limited adjustability with regard to the type of equipment to be supported and the location of anchor points relative to building structure (e.g., for engagement with wall studs).

As well as complicating installation generally, conventional approaches may also increase the difficulty of adjustments after initial installation. Such adjustments, for example, may be useful to fine-tune the location of supported equipment or to accommodate differently sized equipment (e.g., to increase capacity or functionality of previously installed systems). Moreover, these issues (and others) may be compounded by the relatively large manufacturing tolerances that may be typical to metal bracketry and related systems.

As a particular example, conventional mounting system can include pre-formed holes for separately mounting multiple components to a building wall. However, in cases where the distance between studs of the wall does not match the pre-formed holes of the support bar (among other examples), this arrangement may increase the difficultly, time, labor, and overall cost of installing the equipment. Further, even where a main support of a conventional mounting system has been appropriately secured to building structure, additional support members may need to be separately attached to the main support and to the building structure (e.g., also at only select, predetermined locations). This can further compound the lack of adaptability and difficulty of installation noted above, particularly when the additional support members must be re-positioned (and then re-attached) to properly accommodate particular equipment.

Some examples of the disclosed technology can address these or other issues. For example, some configurations include arms that can be easily installed onto corresponding support brackets and easily adjusted to varying locations thereupon as—or once—installed (e.g., with different distances between the arms to accommodate different configurations of supported equipment). Further, in some examples, the arms may be entirely supported by the corresponding support bracket and not separately secured to the corresponding building structure (e.g., a stud or other wall to which the support bracket was previously secured). Thus, for example, an operator can selectively accommodate a wide variety of equipment (or changes in equipment over time) without needing to directly attach the arms to, or detach the arms from, the building structure (e.g., a relevant building wall).

In some examples, arms of a mounting system may be installed on a wall-mounted (or other) bracket in different orientations to account for varying widths of equipment. For example, the arms may be selectively installed in a first orientation to support wide equipment relative to a particular support bracket, or in second orientation to support narrow equipment. Further still, the arms in either the first orientation or the second orientation may be moved along the wall-mounted bracket to account for further variation in the width of the equipment. (As used herein, “wall-mounted” refers to brackets configured to be secured to a vertical or other wall structure. Thus, a wall-mounted bracket may be attachable to a wall, but not necessarily actually attached to a wall, depending on the context of the relevant discussion).

In some examples, arms of a mounting system can be configured to extend in a cantilevered arrangement, supported by multiple cross bars of a mounting bracket. In this regard, for example, an arm can be seated on and below a cross bar that is closer to a building wall and can be seated on and above a cross bar that is farther from the building wall, to provide a cantilevered support for relevant equipment. In this regard, one or more anchor features on the arm can engage one or more of the cross bars to secure the arm in place.

In a particular example, a first end of an arm may include a clamp or other anchor feature (e.g., angle bracket, peg or other protrusion, recess, etc.) that engages a particular cross bar of a mounting bracket. Thus, for example, the arm may be secured by the anchor feature so that the first end of the arm extends below a first cross bar and is thereby (locally) blocked by the first cross bar from moving upward. From the first end and the first cross bar, the arm can extend above a second cross bar of the mounting bracket toward a second end of the arm, so that the arm is thereby (locally) blocked by the second cross bar from moving downward (e.g., with a second anchor feature also engaging the second cross bar). Further, the second end of the arm, on an opposite side of the second cross bar from the first end and the first cross bar, can be configured to be secured to relevant equipment (e.g., to be bolted to an air conditioner, etc.). Accordingly, for example, a set of the arms can be readily adjusted to particular positions along the first and second cross bars and then secured in place on the mounting bracket (e.g., with clamps at one or both of the cross bars) to robustly support equipment having a wide variety of configurations, while requiring minimal direct fastening to building structure and a relatively small spatial (and visual) envelope.

In some examples, a wall-mounted bracket of a mounting system may include pre-drilled (e.g., pre-bored, already-installed, etc.) holes in support members. The pre-drilled holes in the support members may also include a keyhole fitting (e.g., a locking fitting, keyhole locking slot, etc.) which allows a bolt to be installed to a wall and then the bolt be slid into the keyhole fitting and locked (e.g., mounted, installed, etc.) securely.

In some examples, cross supports (e.g., cross bars) of a wall-mounted bracket may provide further support to the mounting system. In some configurations, the cross supports may include pre-drilled holes to allow the mounting system to be installed on a wall with support structures, such as wall studs. The pre-drilled holes in the cross supports may be spaced apart such that the spacing of the pre-drilled holes matches standard spacing for the support structures. Thus, in combination with the lateral adjustability of the arms (e.g., as discussed above), the bracket may provide highly adaptable support for a variety of equipment in a variety of locations.

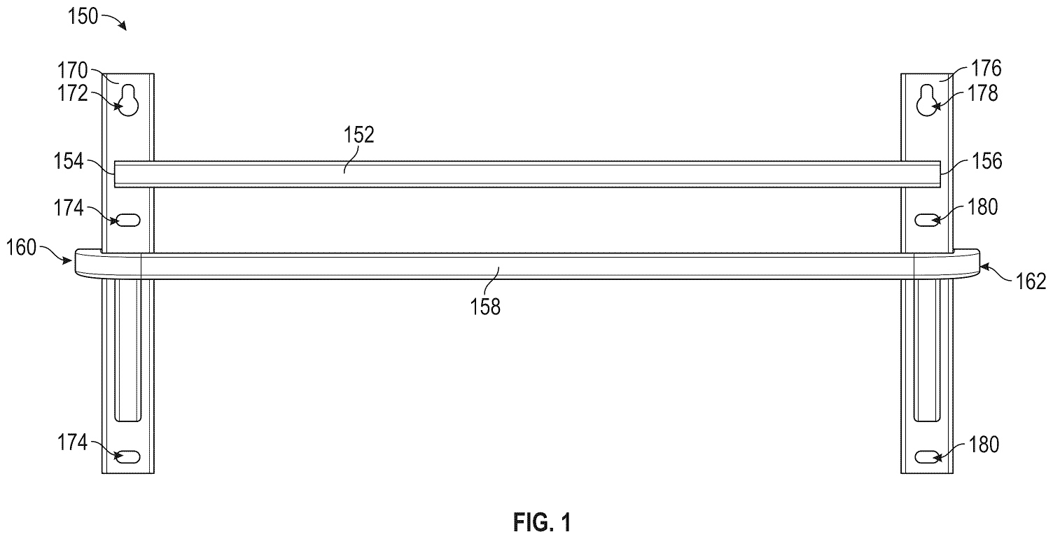

As noted above, a mounting system may include a wall-mounted bracket. FIG. 1 illustrates an example wall-mounted bracket 150 for a mounting system. The wall-mounted bracket 150 includes a first support member 170 and a second support member 176. The wall-mounted bracket 150 further includes a first cross bar 152 and a second cross bar 158 that extend in a lateral direction (e.g., horizontally, as shown). In some embodiments, the wall-mounted bracket 150 may be mounted to a wall (e.g., a concrete wall, as shown). In other embodiments, the wall-mounted bracket 150 may be mounted to other support structures, including posts or wall studs.

In particular, in the illustrated example, the first cross bar 152 is secured at a first end 154 and a second end 156 to the first support member 170 and second support member 176, respectively. The second cross bar 158 is secured to and offset from the support members 170, 176 at first and second ends 160, 162, respectively, of the second cross bar 158. Correspondingly, the first cross bar 152 is closer to the wall than the second cross bar 158 in an installed orientation. In other examples, a similarly offset configuration for cross bars can be otherwise implemented (e.g., with central portions of both cross bars being spaced away from the support members by different distances). However, sets of cross bars may be generally offset away from a wall, as installed, to allow easier anchoring of a relevant arm (as further discussed below)

In some embodiments, the first and second support members 170, 176 are in a vertical orientation, e.g., the first and second support members are vertically oriented and parallel to each other. In some embodiments, the first support member 170 and second support member 176 are horizontally spaced from one another, e.g., the first and second support members are spaced apart from one another along the wall that the wall-mounted bracket is mounted. For example, in FIG. 1, the first support member 170 and second support member 176 are vertically oriented and horizontally spaced apart along the wall that the wall-mounted bracket 150 is mounted to. In some embodiments, the first and second support members are spaced 24 inches apart. In some embodiments, the first and second support members are spaced less than 24 inches apart. In some embodiments, the first and second support members are spaced more than 24 inches apart.

In some embodiments, a first support member and second support member of a wall-mounted bracket may include fastener openings to secure the first and second support members to a wall. In some embodiments, the first and second support members may thus (or otherwise) be securable to distinct support features of the wall (e.g., distinct wall studs).

For example, as shown in FIG. 1, the first support member 170 includes first fastener openings 172, 174, and the second support feature includes second fastener openings 178, 180. In some embodiments, the first and second fastener openings 172, 178 are located at a top end of the first and second support members 170, 176 as shown in FIG. 1. In other embodiments, similar or other fastener openings may be located at other locations on the first and second support members.

In some embodiments, the fastener openings can be keyhole fastener openings, so that a fastener may be inserted at a bottom portion of the fastener opening and the wall-mounted bracket may be slid downward to move the fastener into a top portion of the fastener opening that is narrower than the bottom portion. For example, in FIG. 1, the first fastener opening 172 and second fastener openings 178 are keyhole (or key and slot) fastener openings.

Generally, support members of a wall-mounted bracket may include fastener openings with a variety of numbers, shapes, and locations. For example, as shown in FIG. 1, the fastener openings 174, 180 can be configured as laterally elongate slots, to allow lateral adjustability relative to particular attachment locations on a wall.

Still referring to FIG. 1, the first cross bar 152 and second cross bar 158 are in a horizontal orientation (e.g., the first and second cross bars are horizontally oriented and parallel to each other). In some embodiments, it may be advantageous for the first cross bar and second cross bar to be vertically spaced to provide cantilevered support for equipment mounted to a mounting system via a corresponding arm, as further discussed above and below. For example, in FIG. 1, the first cross bar 152 and second cross bar 158 are vertically spaced from one another (i.e., are offset from each other in the vertical direction).

A mounting system may include also include a set of arms (e.g., two or more arms) configured to support equipment relative to a wall-mounted bracket and thereby support the equipment relative to a wall. In some embodiments, it may be advantageous to include only two arms, although a variety of other configurations are possible.

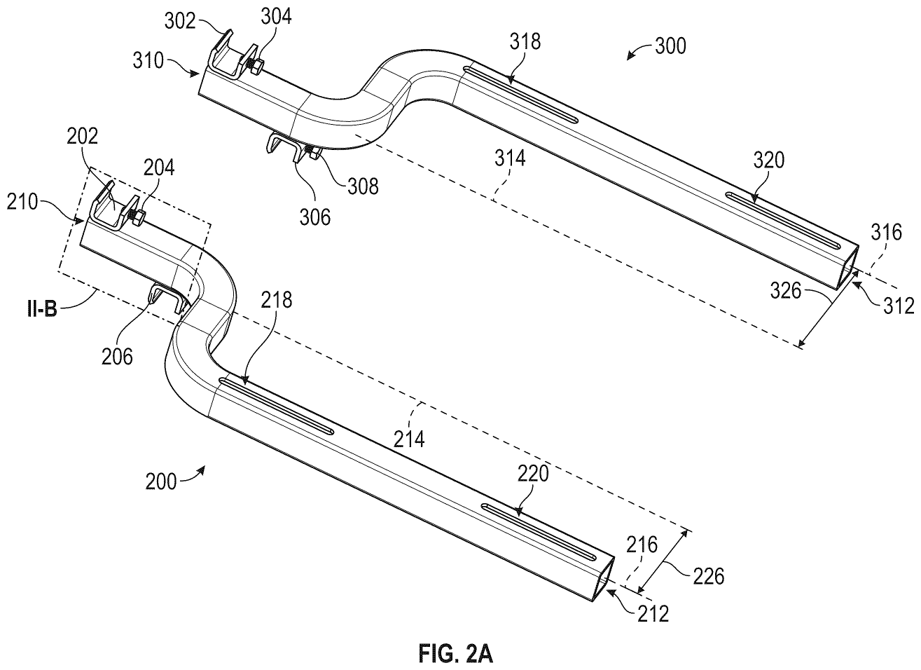

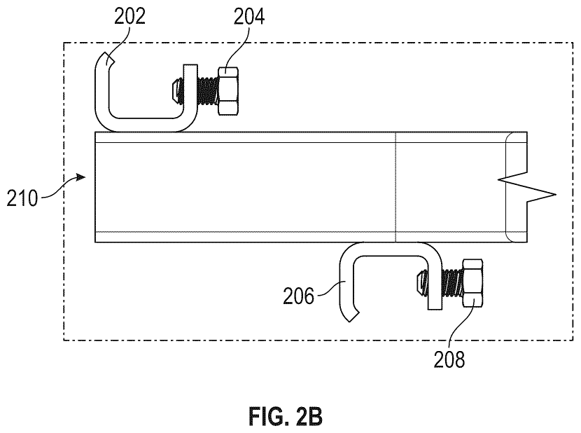

FIG. 2A and FIG. 2B (collectively, herein, “FIGS. 2”) illustrates an example first arm 200 and an example second arm 300, which can be used in a mounting system in combination with the bracket 150 or other brackets. As discussed later in more detail, the arms of the mounting system may be configured to engage with the wall-mounted bracket of the mounting system.

The first arm 200 includes a first end 210, a second end 212. Generally, the second end 212 can be configured to be engaged with equipment to be supported. In the illustrated configuration, for example, the second end 212 includes a first slot 218 and a second slot 220.

The first arm 200 further includes a first anchor feature 202 at the first end 210 and a second anchor feature 206 between the first anchor feature 202 and the second end 212 (e.g., also along the first end 210). The first anchor feature 202 extends in a first direction from a first side of the first arm 200 (e.g., from a top side of the first arm, in a direction normal to the top side of the first arm). The second anchor feature 206 extends in a second direction from a second side of the first arm 200 (e.g., from a bottom side of the first arm, in a direction normal to the bottom side of the first arm). Accordingly, for example, the first direction and second direction for the anchor features 202, 206 can generally be opposite (e.g., opposite and parallel).

In some embodiments, the first anchor feature 202 or the second anchor feature 206 may include a c-shaped clamp (herein, also simply a “c-clamp”). In some installations, a c-clamp can allow for the first anchor feature 202 and second anchor feature 206 to be easily and reliably secured to a first and second cross bar of a wall-mounted bracket. For example, as discussed later, the first and second anchor feature 202, 206 are configured to engage with the first and second cross bars 152, 158 of the wall-mounted bracket 150 to secure the first arm 200 in place.

Additionally, the first anchor feature 202 may include a first set screw 204 and the second anchor feature 206 many include a second set screw 208. The first and second set screw 204, 208 allow the first anchor feature 202 and the second anchor feature 206 to be better secured to the wall-mounted bracket (e.g., with the relevant structure of the bracket captured by the relevant set screw 204, 208 and an opposed angled lip of the relevant c-clamp).

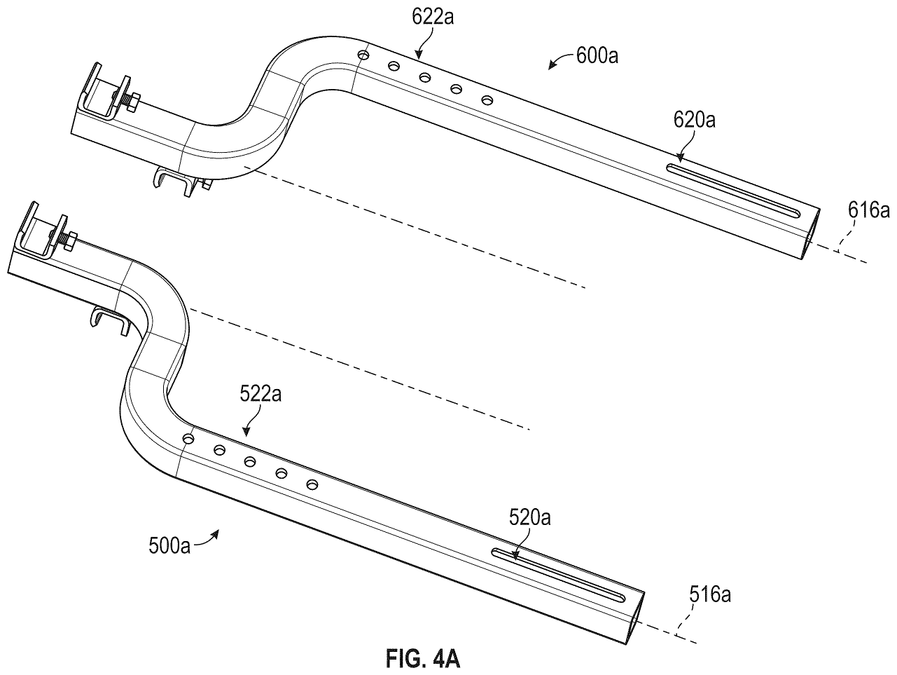

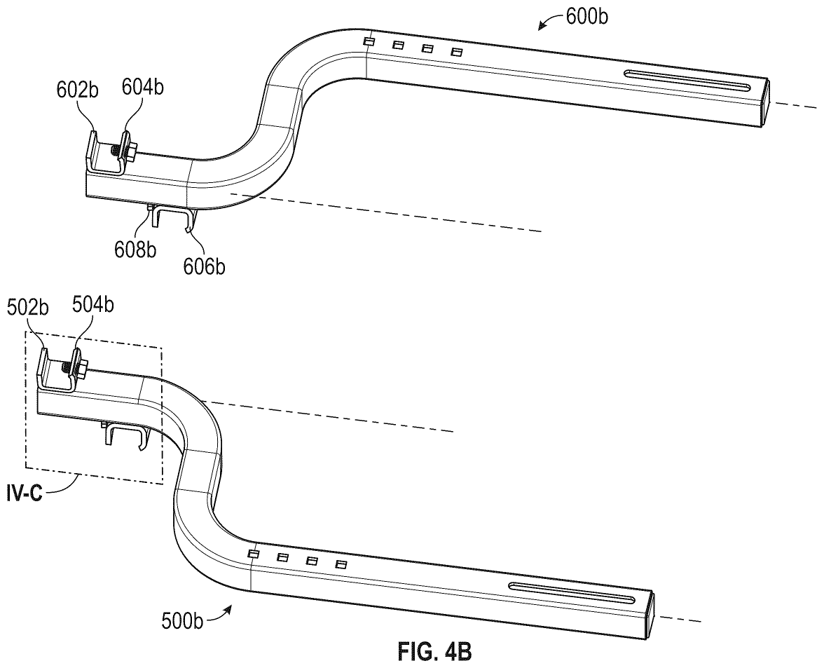

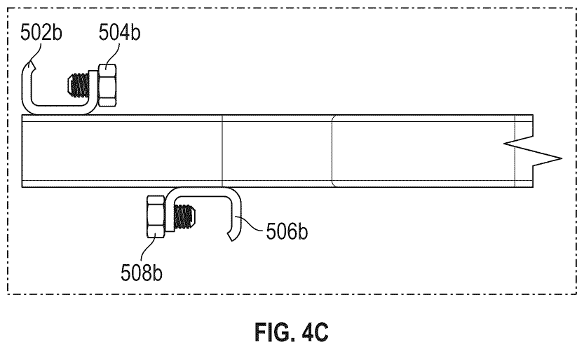

In some embodiments, e.g., as shown in FIGS. 2, the second anchor feature 206 may be oriented so that the second set screw 208 is secured by movement toward a mounting surface of the wall-mount bracket 150 (e.g., as the second set screw is tightened, the second set screw moves toward a wall or other building support structure). In some embodiments, as shown in FIGS. 2, the first anchor feature 202 may be oriented such that the first set screw 204 is secured by movement toward the mounting surface of the wall-mount bracket 150 (e.g., as the first set screw is tightened, the first set screw moves toward the mounting surface). Thus, in some embodiments, the first and second set screws 204, 208 may be oriented such that the first and second set screws 204, 208 are secured by movement toward the mounting surface. In other examples, however, the orientation of one or both of the anchor features 202, 206 may be reversed or otherwise modified (e.g., so that one or both of the set screws 204, 208 may be advanced in an opposite direction than shown in FIGS. 2, including as discussed below relative to the example configuration of FIGS. 4B and 4C).

Still referring to FIG. 2A, the first arm 200 also defines a first arm axis 214 and a second arm axis 216 that is laterally offset from the first arm axis 214. The offset from the first arm axis 214 and the second arm axis 216 defines an offset 226, which corresponds to a lateral offset, from the first end 210, of equipment that is installed at the second end 212 of the first arm 200.

In particular, in the illustrated example, the first end 210 extends along the first arm axis 214, and the second end 212 extends along the second arm axis 216 and is correspondingly laterally offset from the first end 210. As detailed below, laterally offset arm ends (e.g., defined by the offset 226) can allow for increased adaptability in various contexts. However, in some embodiments, the first end and the second end of an arm may extend along the same arm axis. In the illustrated example, the first anchor feature 202 and second anchor feature 206 are located on the first arm 200 along the first arm axis 214. In some embodiments, the second anchor feature 206 may be located on the first arm 200 along the second arm axis 216 (or otherwise).

In the embodiment shown in FIG. 2A, the first slot 218 and second slot 220 of the first arm 200 extend along the second arm axis 216. Similarly, the first slot 218 is the same length as the second slot 220. In other examples, differently sized or oriented slots or other engagement features can be provided.

In some embodiments, inclusion of slots can allow for equipment to be more adaptably secured to the first arm at select locations. Further, slots may allow for equipment to be secured to the first arm, and then moved along the first arm once secured-including with the equipment secured at multiple locations (e.g., along multiple slots). Still further, use of multiple (e.g., first and second) slots may improve the ease of securing equipment to the first arm, as the equipment can be placed on the first arm and initially secured in only one of the first or second slots. Then, the equipment can be further adjusted to position (as needed) before being further secured to the first arm via the second of the first or second slots. In short, with a slotted configuration, the first arm may not require the equipment to be arranged in only a single predefined location on the first arm, for initial attachment or for final securement, but rather may allow equipment to be variously located and secured along the second axis.

In the illustrated example, the second arm 300 is substantially identical to the first arm 200 described above and includes similar numbering in the 300 series as that of the first arm 200. That is, the second arm 300 includes and defines substantially identical components to that of the first arm 200, including a third anchor feature 302, a third set screw 304, a fourth anchor feature 306, a fourth set screw 308, a third end 310, a fourth end 312, a third arm axis 314, a fourth arm axis 316, a third slot 318, a fourth slot 320, and offset 326. Correspondingly, discussion of the structures and functions of first arm 200 herein can also apply equally to the second arm 300, modified as relevant in view of the relative orientation, stage of installation, etc. In other examples, however, differently configured arms may be used.

In some embodiments, it may be advantageous for a wall-mounted bracket to further include a one or more cross supports (e.g., connected together with support members in a unitary, rigid assembly). For example, in some embodiments, one or more cross supports are included in the wall-mounted bracket to allow the wall-mounted bracket to be mounting to wall support feature (e.g., wall studs).

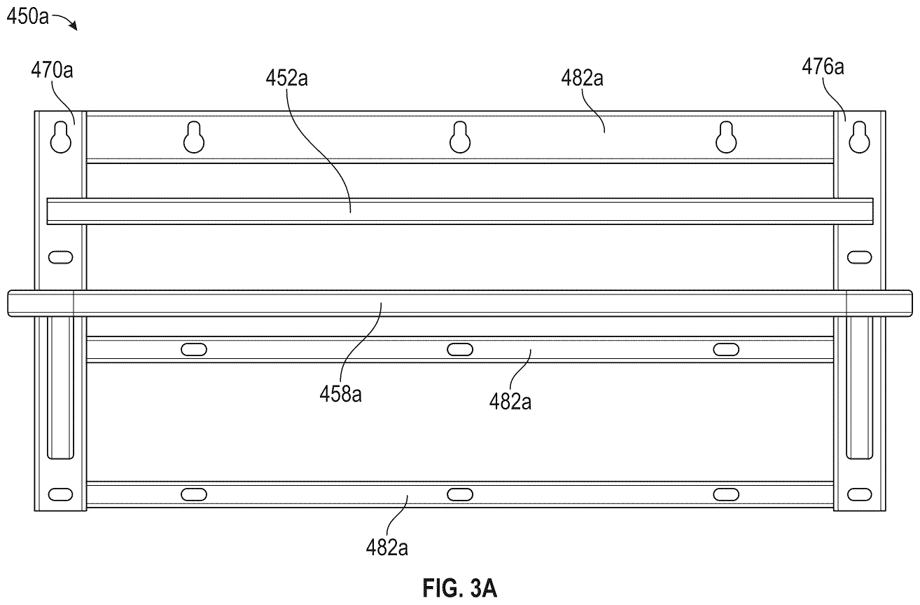

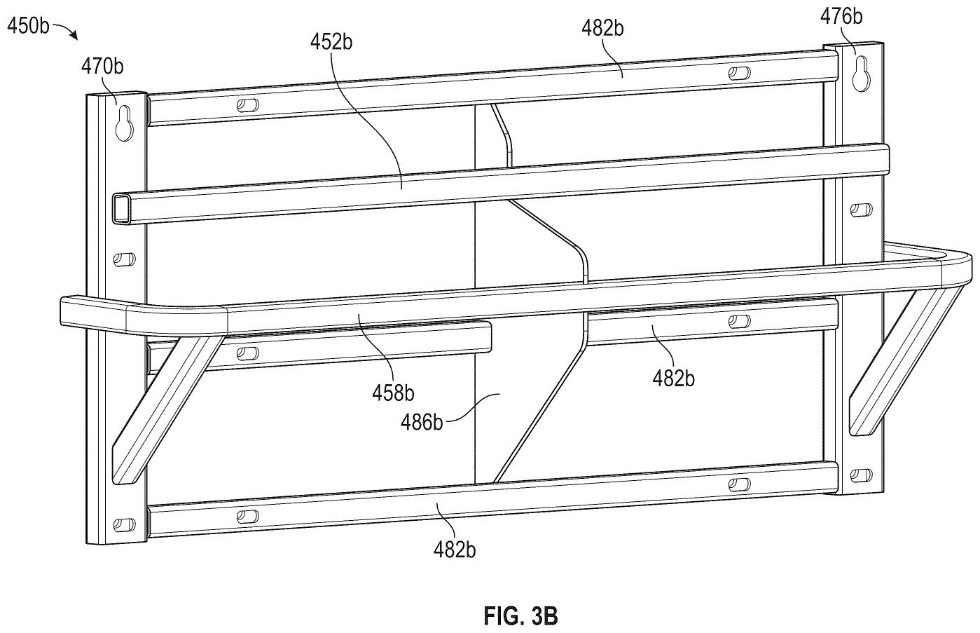

In the example shown in FIG. 3A, a wall-mounted bracket 450a provides an alternate configuration of the bracket 150. Other than as indicated below, the bracket 450a of FIG. 3A is similar to the wall-mounted bracket 150 described above. Correspondingly, the bracket 450a is labeled with similar numbering in the 400 series as that of the wall-mounted bracket 150, and discussion of the numbered features of the bracket 150 also applies to the correspondingly numbered features of the bracket 450a unless otherwise indicated.

In particular, the bracket 450a includes a plurality of cross supports 482a that extend rigidly between (and rigidly interconnect) support members 470a, 476a. In the illustrated example, the cross supports 482a include fastener openings (e.g., slots as shown) and extend in parallel in a lateral direction, similar to a first cross bar 452a and a second cross bar 458a. Also in the example shown, the cross supports 482a are arranged to sit flush against a wall as installed, along with the support members 470a, 476a, although other configurations are possible (e.g., with the support members 470a, 476a or the cross supports 482a arranged to be offset from a wall).

In some instances, fastener openings of one or more of the cross supports 482a of the wall-mounted bracket 450a can be spaced to accommodate particular spacings of studs (e.g., according to standard spacings of 12 inches apart, 16 inches apart, 24 inches apart, etc.). In some embodiments, one or more of the cross supports 482a can include fastener openings configured as keyhole openings, e.g., similar to those of the first and second support members 470a, 476a.

In some embodiments, it may be advantageous for a wall-mounted bracket to further include a center plate or other gusset structure (e.g., a structure that spans top to bottom of the bracket). Such a center plate (or other structure) may add further rigidity to the wall-mounted bracket. For example, in some embodiments, the wall mounted bracket includes a center plate that spans from a top-most cross support to a bottom-most cross support.

In particular, in the example shown in FIG. 3B, a wall-mounted bracket 450b includes a support configured as a unitary support plate 486b. In the example shown in FIG. 3B, the wall-mounted bracket 450b is similar to the wall-mounted bracket 450a of FIG. 3A. Correspondingly, the bracket 450b is labeled with similar numbering in the 400 series as that of the wall-mounted bracket 150, and discussion of the numbered features of the bracket 150 also applies to the correspondingly numbered features of the bracket 450b unless otherwise indicated. Thus, for example, thee first arm 200 and second arm 300 (or other arms) can be installed and secured to the wall-mounted bracket 450b as previously discussed for any of the brackets 150, 450a, and 450b.

In some embodiments, the support plate 486b can be centrally located between first and second support members 470b, 476b. In other embodiments, the support plate 486b may be located closer to one of the first and second support members 470b, 476b. In some embodiments, the support plate 486b can span from a top-most cross support 482b to a bottom-most cross support 482b, as shown in FIG. 3B. The support plate 486b can extend from a mounting surface to one or more cross supports 482b, or first cross bar 452b. As shown in FIG. 3B, the support plate may extend from the mounting surface up to one of the one or more cross supports 482b or extend through the one or more cross supports 482b. The support plate 486b can extend from the mounting surface up to a second cross bar 458b. In some embodiments, the support plate 486b may extend from the mounting surface up through the second cross bar 458b.

In some embodiments, it may be advantageous for the arms of the mounting system to include a plurality of mounting holes. The plurality of mounting holes may advantageously secure equipment to an arm of the mounting system. For instance, if the equipment is secured to one mounting hole of the plurality of mounting holes, the equipment may be further secured to the arm via a slot of the arm (e.g., similar to the second slot 220 of the first arm 200 of FIG. 2A) such that the arm need not be sized for the specific size of the equipment. In other words, although the selected mounting hole may define a particular and discrete connection point, the corresponding slot may allow for the equipment to be further secured with a variety of fastener spacings along the arm. Further, when the equipment is secured to one hole of the plurality of mounting holes, the equipment may securely locked in place, as the plurality of mounting holes many perform as a pin-in-slot fastener once the equipment is secure (e.g., the equipment may include a component that includes a pin that is inserted in one hole of the plurality of mounting holes).

As one example, as shown in FIG. 4A, a first arm 500a and a second arm 600a may be substantially identical to the first arm 200 and the second arm 300 as discussed above, with respect to most components, including a second arm axis 616a, a fourth slot 620a, and a plurality of mounting holes 622a. Correspondingly discussion of the numbered features of the arms 200, 300 also applies to the correspondingly numbered features of the arms 500a, 600a, unless otherwise indicated. In contrast to the arms 200, 300, however, the first arm 500a includes a plurality of mounting holes 522a and a slot 520a that extends along a second arm axis 516a. In some embodiments, the plurality of mounting holes 522a may extend along the second arm axis 516a, as shown in FIG. 4A, or may be otherwise oriented.

In some embodiments, it may be advantageous to include arms that have anchor features that have a set screw that is oriented towards a mounting structure. For example, as shown in FIG. 4B and FIG. 4C, a second anchor feature 506b of first arm 500b, configured as a c-clamp with an inwardly angled lip, may be oriented so that a second set screw 508b is secured by movement away from a mounting surface of the relevant wall-mount bracket 150, 450a, or 450b (e.g., as the second set screw is tightened, the second set screw moves away from the mounting surface). In some embodiments, as shown in FIGS. 4B and 4C, a first anchor feature 502b may be oriented oppositely, such that a first set screw 504b is secured by moving toward the mounting surface of the wall-mount bracket 150, 450a, or 450b (e.g., as the first set screw is tightened, the first set screw moves toward the mounting surface).

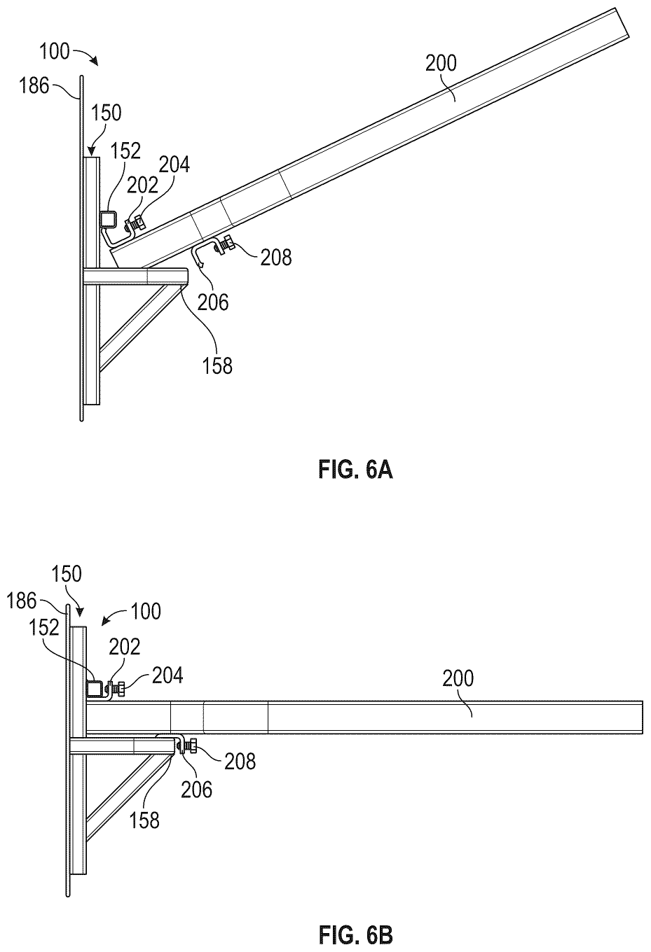

Thus, in some embodiments, a lower-height wall of a clamp—e.g., the lower-height wall of the clamp that is opposite the set screw for the second anchor feature 506b—may be oriented to closer to relevant cross bar (e.g., the cross bar 158). Correspondingly, the associated arm may need to be tilted only to a relatively shallow angle relative to horizontal so that (lower-height) wall of the clamp (e.g., the second anchor feature 506b) clears the cross bar to engage the clamp with the cross bar. Thus, for example, installation of the disclosed arms may be achieved with relatively small deviation of the arm from horizontal (e.g., and correspondingly small required tilting of supported equipment), including during an installation of the configurations of FIGS. 4B and 4C according to the approach shown in FIGS. 6A and 6B.

Also shown in FIG. 4B, a second arm 600b may be similar to the first arm 500b, and discussion of the arm 500b may also apply to the arm 600b. For example, arm 600b includes a first anchor feature 602b, a first set screw 604b, second anchor feature 606b, and second set screw 608b.

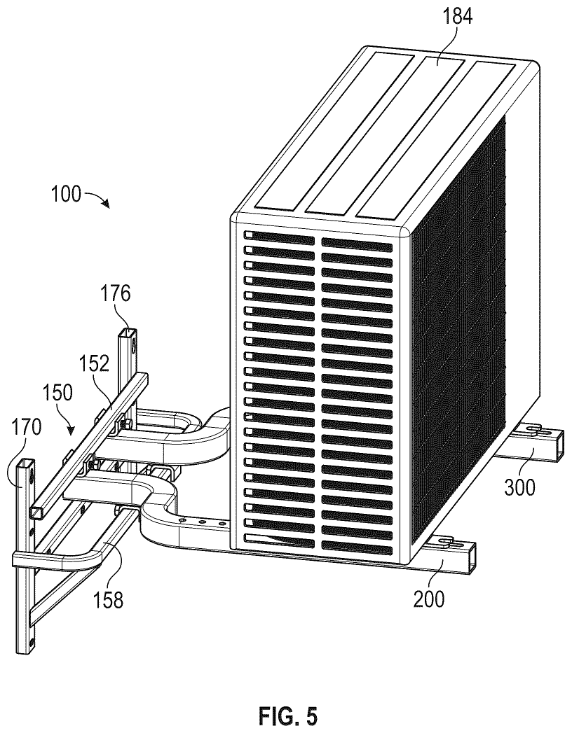

In some embodiments, a mounting system includes a wall-mounted bracket and arms secured to a wall. For example, now referring to FIG. 5, a mounting system 100 includes the wall-mounted bracket 150, the first arm 200, and the second arm 300. The wall-mounted bracket 150 can be secured to a support structure (e.g., concrete or stud wall) and equipment 184 may be supported thereby via the first arm 200 and the second arm 300. Specifically, the equipment 184 may be mounted to the arms 200, 300 via the slots 218, 220, 318, 320 (see FIG. 2A). In some embodiments, the equipment 184 may include a heat pump, an air conditioning unit, a refrigerator, or various other devices or assemblies that may need to be elevated above a surface. In other examples, the arms 200, 300 may be configured instead as shown for the arms 500a, 600a, as shown for the arms 500b, 600b, with installation steps otherwise as discussed herein for the arms 200, 300.

In some embodiments, the wall-mounted bracket 150 or other wall-mounted bracket of a mounting system can be installed to a wall. In some embodiments, the wall-mounted bracket may be held in a desired location along the wall to locate the positions for fastener openings on the wall, e.g., to be marked on the wall through holes in the bracket. Once the location of the fastener openings has been determined, the wall-mounted bracket may be set down, and fasteners may be installed on the wall accordingly. Then, the wall-mounted bracket may be secured to the wall by engaging the installed fasteners with relevant fastener openings (e.g., a keyhole opening or a slot in a support member). In other embodiments, a wall-mounted bracket can be installed to the wall by holding the wall-mounted bracket to the wall and installing fasteners through fastener openings of relevant support members).

Once a wall-mounted bracket is secured to a wall, a first arm and second arm may be secured to the wall-mounted bracket. As shown in FIG. 6A, the wall-mounted bracket 150 is installed to a wall 186 with the first and second arms 200, 300 secured thereto. In particular, the arms 200, 300 extend below the first cross bar 152 and above the second cross bar 158. Accordingly, the arms 200, 300 are in cantilevered support relative to the wall-mounted bracket 150 so the mounting system 100 can support the equipment 184. Although not expressly shown in FIG. 6A, the arms 200, 300 can be similarly installed in the mounting system 100 with the configuration shown in FIGS. 4B and 4C, and with potentially reduced angular deviation from horizontal, as also noted above.

In some examples, as shown in FIG. 6B, the first anchor feature 202 of the first arm 200 engages with the first cross bar 152, and a second anchor feature 206 of the first arm 200 engages with the second cross bar 158. In some examples, as also shown in FIG. 6B, the first set screw 204 and the second set screw 208 may be engaged with the first cross bar 152 and the second cross bar 158, respectively, to further secure the first arm 200 to the wall-mounted bracket 150.

As the second arm 300 is substantially identical to the first arm 200, the second arm 300 may be secured to the wall-mounted bracket 150 with the same approach as described for the first arm 200, above. In some cases, the equipment 184 may then be installed to the first and second arms 200, 300 (e.g., after the first and second arms 200, 300 are secured to the wall-mounted bracket 150). In other embodiments, however, one or more arms may be installed first to a wall-mounted bracket before the collective mounting system is secured to a wall. Further, in other embodiments, the equipment can be secured to the first and second arms, and then the equipment, the first arm, and the second arm can be secured to the wall-mounted bracket (e.g., after the wall-mounted bracket is already secured to the wall). In particular, the relatively easy installation process for the cantilevered arms (e.g., as shown in FIGS. 6A and 6B) may greatly improve ease of installation for such an approach (e.g., particularly with reduced tilting of the arms as provided by orientation of anchor features as described for arms 500a/b, 600a/b). In still other embodiments, the equipment can be secured to one or more arms, then the arm(s) secured to a bracket, and then the collectively assembly secured to the wall.

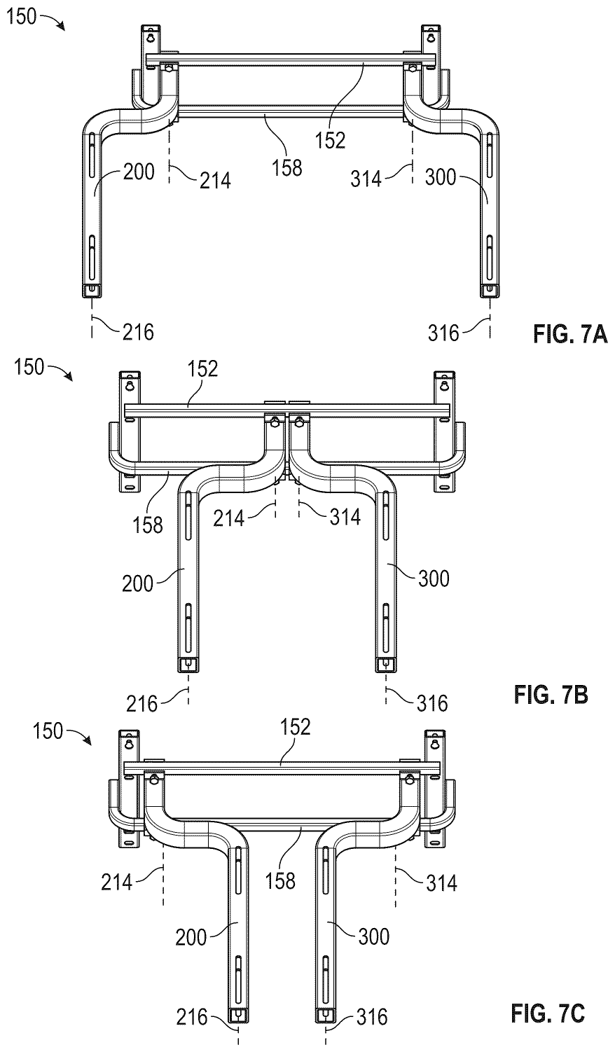

In some embodiments, it may be advantageous for the arms of the mounting system to be in various installed orientations. For instance, as shown in FIG. 7A, the first arm 200 and second arm 300 (or the arms 500a, 600a, or the arms 500b, 600b) may be oriented in a first installation orientation so that the second arm axis 216 and the fourth arm axis 316 are laterally between the first arm axis 214 and the third arm axis 314. The first installation orientation of the first and second arms 200, 300, for example, may accommodate narrow equipment and generally reduce a protruding footprint of the installed system. In some embodiments, the first arm 200 and the second arm 300 may be oriented in a second installation orientation so that the first arm axis 214 and the third arm axis 314 are laterally between the second arm axis 216 and fourth arm axis 316, as shown in FIGS. 7B and 7C. The second installation orientation of the first arm 200 and second arm 300, for example, may accommodate wide equipment, including equipment that is wider than the support bracket 150.

Thus, example of the disclosed technology can provide improved systems and methods for supporting equipment relative to the ground, particularly for wall-mounted configurations. For example, as detailed above, some configurations can allow for simplified installation, and a more adaptable configuration relative to different types of equipment or installation locations.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “substantially parallel” indicates a direction that is within ±12 degrees of a reference direction (e.g., within ±6 degrees or ±3 degrees), inclusive. Similarly, unless otherwise limited or defined, “substantially perpendicular” similarly indicates a direction that is within ±12 degrees of perpendicular a reference direction (e.g., within ±6 degrees or ±3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise limited or defined, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or using a single mold, without rivets, screws, other fasteners, or adhesive to hold separately formed pieces together is an integral (and integrally formed) element. In contrast, an element formed from multiple pieces that are separately formed initially then later connected together, is not an integral (or integrally formed) element.

As used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

The previous description of the disclosed examples is provided to enable any person skilled in the art to make or use the disclosure. Various modifications to these examples will be readily apparent to those skilled in the art, and the generic principles defined herein may be applied to other examples without departing from the spirit or scope of the disclosed technology. Thus, the disclosure is not intended to be limited to the examples shown herein but is to be accorded the widest scope consistent with the principles and novel features disclosed herein.

I claim:

1. A mounting system for equipment, the mounting system comprising:
a wall-mounted bracket that includes a support member securable to a wall, a first cross bar that extends in a lateral direction, supported by the support member, and a second cross bar that extends in the lateral direction, supported by the support member;
a first arm that includes a first end with a first-arm anchor feature and a second end configured to be secured to equipment; and
a second arm that includes a third end with a second-arm anchor feature and a fourth end configured to be secured to the equipment;
the first-arm anchor feature removably engaging the first cross bar to secure the first arm to the first cross bar, with the first arm extending below the first cross bar and the first arm extending above the second cross bar to be removably seated on the second cross bar, so that the second end of the first arm extends transverse to the lateral direction to support the equipment with cantilevered support relative to the wall-mounted bracket; and
the second-arm anchor feature removably engaging the first cross bar to secure the second arm to the first cross bar, with the second arm extending below the first cross bar and the second arm extending above the second cross bar to be removably seated on the second cross bar, so that the fourth end of the second arm extends transverse to the lateral direction to support the equipment with cantilevered support relative to the wall-mounted bracket.

2. The mounting system of claim 1, wherein the first end of the first arm extends along a first arm axis and the second end of the first arm extends along a second arm axis that is laterally offset from the first arm axis; and
wherein the third end of the second arm extends along a third arm axis and the fourth end of the second arm extends along a fourth arm axis that is laterally offset from the third arm axis.

3. The mounting system of claim 2, wherein the first and second arms are selectively securable in a first installation orientation or a second installation orientation;
wherein, in the first installation orientation, the second and fourth arm axes are laterally between the first and third arm axes; and
wherein, in the second installation orientation, the first and third arm axes are laterally between the second and fourth arm axes.

4. The mounting system of claim 1, wherein the first-arm anchor feature and second-arm anchor feature each include a c-clamp, wherein the c-clamp includes a set screw arranged to secure the first cross bar within the c-clamp.

5. The mounting system of claim 1, wherein the first end of the first arm further includes a second first-arm anchor feature that removably engages the second cross bar to secure the first arm to the second cross bar; and
wherein the third end of the second arm further includes a second second-arm anchor feature that removably engages the second cross bar to secure the second arm to the second cross bar

6. A mounting system for equipment, the mounting system comprising:
a bracket that includes a support member, a first cross bar that extends in a lateral direction, supported by the support member, and a second cross bar that extends in the lateral direction, supported by the support member; and
an arm that includes a first end with a first anchor feature and a second end configured to be secured to equipment;
the first anchor feature removably engaging one of the first cross bar or the second cross bar to secure the arm to the bracket, with the arm seated on and below the first cross bar, the arm seated on and above the second cross bar, and the second end of the arm extending away from the bracket, transverse to the lateral direction, to support the equipment in cantilevered support relative to the bracket.

7. The mounting system of claim 6, wherein the arm further includes a second anchor feature between the first anchor feature and the second end of the arm;
wherein the first anchor feature removably engages the first cross bar; and
wherein the second anchor feature removably engages the second cross bar to further secure the arm to the bracket.

8. The mounting system of claim 7, wherein the first anchor feature extends in a first direction from a first side of the arm; and
wherein the second anchor feature extends in a second direction from a second side the arm, opposite the first direction and the first side.

9. The mounting system of claim 6, further comprising:
a second arm that includes a third end with a third anchor feature and a fourth end configured to be secured to the equipment;
wherein the third anchor feature removably engages one of the first cross bar or the second cross bar to secure the second arm to the bracket, with the second arm below the first cross bar, the second arm removably seated on and above the second cross bar, and the fourth end of the second arm extending transverse to the lateral direction to support the equipment in cantilevered support relative to the bracket.

10. The mounting system of claim 9, wherein the first end of the arm extends along a first arm axis and the second end of the arm extends along a second arm axis that is laterally offset from the first arm axis; and
wherein the third end of the second arm extends along a third arm axis and the fourth end of the second arm extends along a fourth arm axis that is laterally offset from the third arm axis.

11. The mounting system of claim 10, wherein:
in a first installation orientation, the second and fourth arm axes are laterally between the first and third arm axes; and
in a second installation orientation, the first and third arm axes are laterally between the second and fourth arm axes.

12. The mounting system of claim 6, wherein the first anchor feature includes a c-clamp with an angled lip.

13. The mounting system of claim 6, wherein the support member is a first support member;
wherein the bracket further includes a second support member that further supports the first and second cross bars; and
wherein each of the first and second cross bars extends laterally between the first support member and the second support member.

14. The mounting system of claim 13, wherein, relative to an installed orientation of the mounting system on a wall, the first cross bar is above the second cross bar and closer to the wall than is the second cross bar.

15. The mounting system of claim 13, wherein the bracket further includes:
one or more cross supports that extend laterally between the first and second support members.

16. A method of supporting equipment, the method comprising:
securing a support member of a bracket to a support structure, with a first cross bar of the bracket extending in a lateral direction, supported by the support member, and a second cross bar of the bracket extending in the lateral direction, supported by the support member;
providing an arm that includes a first end with a first anchor feature and a second end;
removably engaging the first anchor feature with one of the first cross bar or the second cross bar to secure the arm to the bracket, with the arm seated on and below the first cross bar, the arm is seated on and above the second cross bar, and the second end of the arm extending away from the bracket, transverse to the lateral direction; and
securing the equipment to the second end of the arm so that, with the arm secured to the bracket, the arm supports the equipment in cantilevered support relative to the bracket.

17. The method of claim 16, wherein the arm further includes a second anchor feature between the first anchor feature and the second end of the arm; and
wherein securing the arm to the bracket includes:
removably engaging the first anchor feature with the first cross bar; and
removably engaging the second anchor feature with the second cross bar.

18. The method of claim 17, further comprising:
providing a second arm that includes a third end with a third anchor feature and a fourth end;
removably engaging the second anchor feature with one of the first cross bar or the second cross bar to secure the second arm to the bracket, with the second arm seated on and below the first cross bar, the second arm seated on and above the second cross bar, and the fourth end of the second arm extending away from the bracket, transverse to the lateral direction; and
securing the equipment to the fourth end of the second arm so that, with the second arm secured to the bracket, the second arm further supports the equipment in cantilevered support relative to the bracket.

19. The method of claim 18, wherein the first end of the arm extends along a first arm axis and the second end of the arm extends along a second arm axis that is laterally offset from the first arm axis; and
wherein the third end of the arm extends along a third arm axis and the fourth end of the arm extends along a fourth arm axis that is laterally offset from the third arm axis.

20. The method of claim 19, wherein securing the arm and the second arm to the bracket includes, selectively:
for a first installation orientation, securing the arm and the second arm so that the second and fourth arm axes are laterally between the first and third arm axes; and
for a second installation orientation, securing the arm and the second arm so that the first and third arm axes are laterally between the second and fourth arm axes.
